(19) United States
(12) Patent Application Publication
(10) Pub. No.: US 2016/0379270 A1
(43) Pub. Date: Dec. 29, 2016

(54) SYSTEMS AND METHODS FOR CUSTOMIZED INTERNET SEARCHING AND ADVERTISING

(71) Applicant: OpenDNA Limited, Northwich (GB)

(72) Inventors: Jay Shah, London (GB); George Irwin, Banffshire (GB)

(21) Appl. No.: 15/192,338

(22) Filed: Jun. 24, 2016

Related U.S. Application Data
(60) Provisional application No. 62/184,197, filed on Jun. 24, 2015.

(51) Int. Cl. G06Q 30/02; G06F 17/30

(52) U.S. Cl. CPC G06Q 30/0269; G06F 17/30864; G06Q 30/0277

(57) ABSTRACT

A system and method that provides contextualized content to a user is disclosed. The system receives content pieces such as text, audio, or video, and generates a jott for each received content piece. Each generated jott includes a taxonomical classification or a named entity, and a corresponding relevancy score. The system generates a core data structure for a user, which includes one or more taxonomical classifications or named entities in which the user has expressed an interest, and which also includes a corresponding weight value. The system determines matching jotts based on a comparison of the generated jotts to the generated core data structure for the user, and the system displays an indication of the matching jotts in a fashion that allows the user to select a jott for display. In addition, the system allows the user to view, modify, and control the dissemination of information that the system maintains regarding the user.

### CROSS-REFERENCE TO RELATED APPLICATION

This application claims the benefit of U.S. Provisional Patent Application No. 62/184,197, entitled “Systems and Methods for Customized Internet Searching and Advertising,” filed Jun. 24, 2015, the entirety of which is incorporated herein by reference.

### BACKGROUND

The sheer vastness of information available through conventional Internet search engines and websites often results in a deluge of information that is not particularly relevant or useful to consumers of electronic information. This unfortunate result is not only a common annoyance to users, but is also a time consuming and expensive reality for many users in terms of wasted bandwidth, wasted productivity, and general frustration. Traditional search engines and websites similarly fail with regard to advertisers and publishers, who spend substantial financial resources in an attempt to reach users who are more likely to purchase or otherwise consume goods or services being offered. Traditionally, the many failings of search engines and websites can be attributed, at least in part, to a lack of detailed and highly contextualized information that could otherwise be used to conduct a more intelligent search or recommendation. Even conventional systems that have attempted to make use of enhanced user information have nevertheless failed to collect such information with the comprehensiveness, detail, and speed that is necessary to provide more meaningful search results and recommendations, and, by extension, an enhanced user experience.

Moreover, conventional systems have failed to provide adequate safeguards to allow users to control their personalized information. Indeed, rather than decentralizing users' personalized information, conventional systems have largely locked up this sensitive information in electronic data silos that afford individual users little or no opportunity to exercise control over sensitive information that they may or may not want to share or store electronically.

Therefore, there is a need for a system that provides more intelligent search results and content recommendations based on highly contextualized personal information for which the user has transparency, consent, and control.

### BRIEF DESCRIPTION OF THE DRAWINGS

FIG. 1 is a block diagram illustrating an environment in which a customized searching and advertising system operates in some embodiments.

FIG. 2 is a block diagram illustrating the customized searching and advertising system in more detail.

FIG. 3 is a flowchart showing a method implemented by the customized searching and advertising system to process a new jott that is added to the system.

FIG. 4A is a flowchart showing a method implemented by the customized searching and advertising system for processing a user interaction with a jott.

FIG. 4B is a flowchart showing a method implemented by the customized internet searching and advertising system for updating a matching matrix in response to receiving information about a user.

FIG. 5 is a sample privacy user interface for allowing a user to control the user's personalized information that is maintained by the customized searching and advertising system.

### DETAILED DESCRIPTION

A system and method that provides contextualized content to a user and allows user control of personalized information is disclosed. The disclosed system is adapted to accept content from diverse sources, analyze the content, and convert the content to a “jott,” which is contextualized, intelligent content uniquely relevant to its reader. The system then makes the jott available to users. A jott is a piece of content that the system has analyzed and stored in order to recommend to users for whom the content is known or believed to be relevant. A jott may contain text, an image, a video, an audio file, or any combination thereof. When a user interacts with a jott, an action record is created, storing the time spent viewing the jott and whether the interaction was negative, neutral, or positive. The system then enriches that action with statistical data (such as the user's location, weather, time of day, date, or health data such as heart rate and blood pressure, which all may provide context to the user's action). The statistical data may be stored in raw form, may contribute to the system's understanding of the user's interests (e.g., running, health, fitness), and may be accessible to the user and authorized applications (including applications made available by OpenDNA) as raw data, visualized over time. The system protects the user's personalized information by allowing the user to maintain transparency, consent, and control of the information. In particular, the system provides the user the ability to view the information that the system maintains with regard to the user; adjust, delete, or add to the information; and control which information may be shared with other parties and which information may not be shared. Because the system enables compatibility with a host of authorized applications, the system's privacy controls apply equally to third-party applications, thereby providing users of the system with a single point of reference for managing, viewing, and controlling access to the user's personalized data across multiple platforms.

The system stores information for each user in a core data structure comprising a unique set of data points that represent the outcome of a complex analysis. The core data structure allows the system to make received content relevant to users of the system. As described in more detail below, content relevance is measured using periods of time and the meaning and context of a piece of content. The core data structure allows the system to apply a weight (or score) to a taxonomical classification or named entity in which a user has shown interest. The value of the weight may be represented on a numeric scale (e.g., from 0 to 10) and gives an indication of the degree to which a user is interested in the associated taxonomical classification or named entity. The system is then able to apply the weight as an offset value to processes pertaining to search results and content sorting. The system knows the context of each piece of content and each available search result. As a result, when returning information for a user, the system is able to calculate a unique score for each information piece, and return information and search results to the user in a prioritized fashion based on the user's preferences.

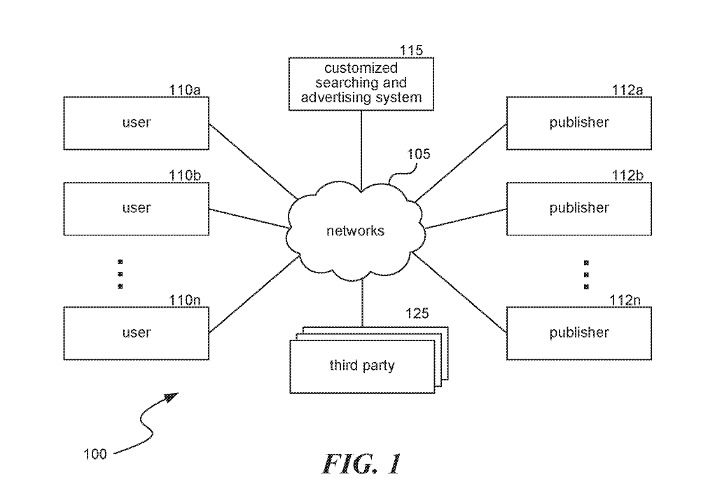

FIG. 1 is a block diagram illustrating an environment 100 in which a customized searching and advertising system 115 operates in some embodiments. Although not required, aspects and implementations of the system will be described in the general context of computer-executable instructions, such as routines executed by a general-purpose computer, a personal computer, a server, or other computing system. The system can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the system described herein may be stored or distributed on tangible, non-transitory computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer, while corresponding portions reside on a client computer.

Referring to the example of FIG. 1, the customized searching and advertising system 115 is communicably coupled to one or more users 110 (shown individually as users 110a-110n) via one or more networks 105. The customized searching and advertising system 115 is also communicably coupled to one or more publishers 112 (shown individually as publishers 112a-112n) and third parties 125 via the networks 105. Networks 105 are any network suitable for communicably coupling the users 110, the publishers 112, the third party (or third parties) 125, and the customized searching and advertising system 115, such as a cellular telecommunications network, a public-switched telephone network (PSTN), any combination of these networks, or any other suitable network that can carry data communications. The users 110, publishers 112, third parties 125, and customized searching and advertising system 115 may also communicate with each other via public or private networks 105, including for example, the Internet.

The users 110, publishers 112, and third parties 125 may have mobile devices and computers that are utilized for communicating with the customized searching and advertising system 115 through the networks 105. Any mobile devices may communicate wirelessly with a base station or access point using a wireless mobile telephone standard, such as the Global System for Mobile Communications (GSM), Long Term Evolution (LTE), or another wireless standard, such as IEEE 802.11, and the base station or access point may communicate with the customized searching and advertising system 115 via the networks 105. Computers may communicate through the networks 105 using, for example, TCP/IP protocols.

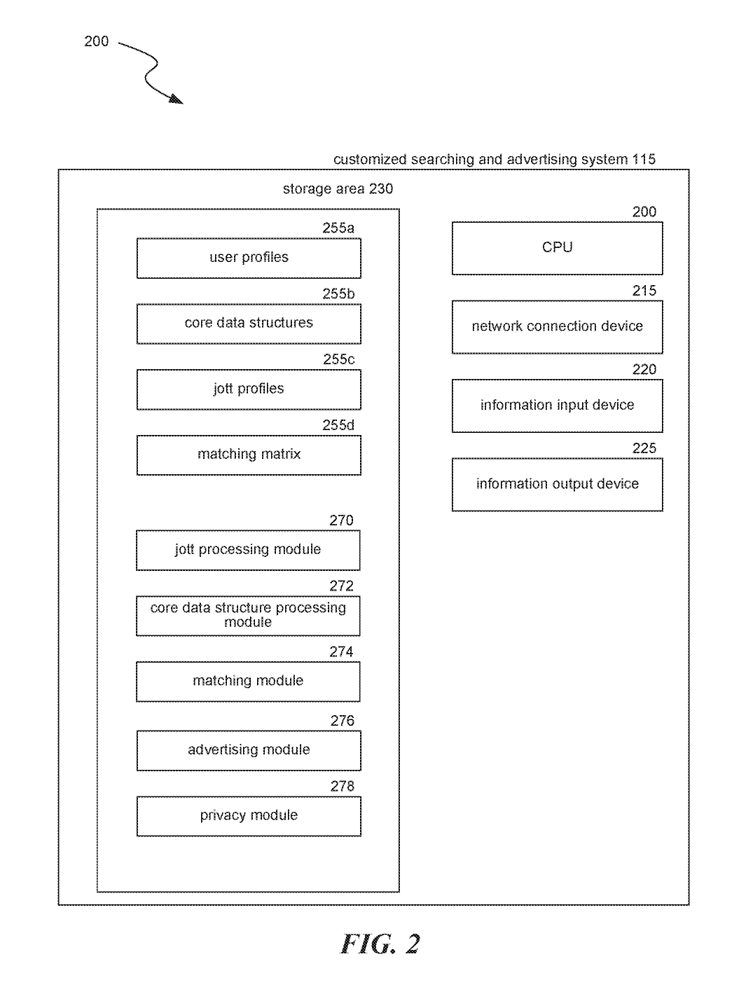

FIG. 2 is a block diagram illustrating the customized searching and advertising system 115 in more detail. The customized searching and advertising system 115 includes a storage area 230. The storage area 230 includes software modules and data that, when executed or operated on by a processor, perform certain of the methods or functions described herein. The storage area may include components, subcomponents, or other logical entities that assist with or enable the performance of some or all of these methods or functions. For example, the modules may in some embodiments be utilized to implement a jott processing module 270 that, for example, adds new jotts to the system and updates jotts in response to a user's interaction with one or more jotts; a core data structure processing module 275 that, for example, maintains user profile information and updates a user's core data structure in response to the user's interaction with a jott or in response to receiving additional information about the user (e.g., biometric or location data); a matching module 274 that, for example, matches a user's interests to the content contained in one or more jotts maintained by the system and inserts a relevant jott into a user's personalized content stream; an advertising module 276 that, for example, allows a publisher, third party, or another user to create an advertisement and submit the advertisement to the system; and a privacy module 278 that, for example, allows a user to view, edit, and control sharing of information maintained by the system that pertains to the user. Each of these modules is discussed in more detail below.

The customized searching and advertising system 115 further includes one or more central processing units (CPU) 200 for executing software stored in the storage area 230, and a computer-readable media drive for reading information or installing software from tangible computer-readable storage media, such as a floppy disk, a CD-ROM, a DVD, a USB flash drive, and/or other tangible computer-readable storage media. The customized searching and advertising system 115 also includes one or more of the following: a network connection device 215 for connecting to a network, an information input device 220 (for example, a mouse, a keyboard, etc.), and an information output device 225 (for example, a display).

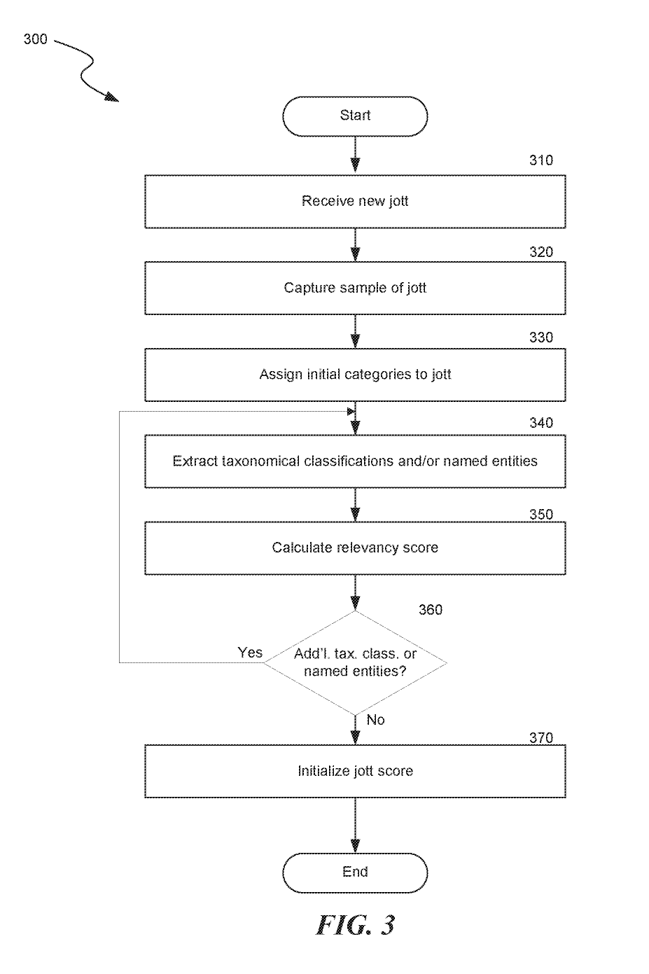

FIG. 3 is a flowchart 300 showing a method implemented by the customized internet searching and advertising system to process a new jott that is added to the system. At step 310, the system receives a new jott to be subsequently made available to users. The content of a jott comprises text, audio, or video that is provided by the jott's publisher and/or available on an external website that is referenced by the jott. The system may receive the new jott from a variety of diverse sources, including without limitation publishers of online or print publications, advertisers across a variety of industries, political organizations, government or service agencies, and educational or scientific organizations, online retail outlets or medical institutions. The new jott may be provided through RSS feeds, third-party APIs, or user created or generated content. In one embodiment, the system converts received content to jotts by querying the source of an RSS feed, or connecting to a third-party API to retrieve raw content (e.g., text, video, or audio).

At step 320, the system extracts a sample from the received content, such as a text snippet from the received content. The system may extract an image URL and a link back to the original source content (if available), and stores the data to enable subsequent processing of the received content. In addition, the system may extract a logo or icon for the publishing entity in order to ensure that the system may provide proper attribution for the original content. The system then submits the content for Natural Language Processing (NLP) analysis. The system may submit the entire web page for analysis in order to gain deeper insight into the content's context, or, if a web page is not available, the extracted sample is submitted for NLP analysis. At step 330, the system assigns one or more initial categories to the jott. The system uses the one or more initial categories to initialize profiles of users who are relatively new to the system or who are using the system for the first time. For example, the system may assign a high-level initial category corresponding to “sports” or “dining” to a new jott. If a new or relatively new user engages with a jott, then the jott's one or more initial categories are used to immediately return more relevant content to the user until the user performs enough actions to allow the system to build a detailed user profile in accordance with embodiments disclosed herein.

At step 340, the system extracts one or more named entities and/or taxonomical classifications from the content of the jott. The system may extract the one or more named entities and/or taxonomical classification by a variety or means, including by using natural language processing. A taxonomical classification may correspond to a general category in which a user may express interest, such as fitness, architecture, history, politics, or technology. A named entity may correspond to a particular person or entity (as opposed to a general category) that is referenced in a jott, such as “Annie Leibovitz,” “Rockefeller Center,” or “Charles de Gaulle Airport.” A person of ordinary skill in the art will appreciate that any number of taxonomical classifications and named entities are possible and are not limited by the representative examples provided herein. The system may represent or store each extracted taxonomical classification or named entity in a variety of formats. For example, in one embodiment, the system may store an example taxonomical classification as {‘/finance/personal finance/lending/credit cards’: 0.789} and may store an example named entity as {‘Alexander Graham Bell’: 0.823}. In both representative examples, the numbers 0.789 and 0.823 each correspond to a raw relevancy score, as discussed in further detail below.

At step 350, the system calculates a relevancy score for each named entity and/or taxonomical classification. The calculated relevancy score is indicative of an accuracy of the named entity or taxonomical classification to a corresponding jott. In one embodiment, the system may calculate a relevancy score by separating a taxonomical classification or named entity into its constituent parts, applying a rounded multiplication to the raw score, and applying the resulting relevancy score to each of the constituent parts. Although certain embodiments are compatible with structured navigation of content categories, in other embodiments the system neither requires nor expects structured navigation of content categories. Continuing with the above example taxonomical classification {‘/finance/personal finance/lending/credit cards’: 0.789}, the system may multiply raw score 0.789 by a multiplication factor 10 (i.e., 0.789*10=7.89), and then round the result to the nearest whole number, resulting in a relevancy score of 8. In this representative embodiment, the system would then apply the relevancy score to each constituent component of the taxonomical classification, resulting in following calculated relevancy scores: finance=8; personal finance=8; lending=8; and credit cards=8. Similarly, continuing with the above example named entity {‘Alexander Graham Bell’: 0.823}, the system may multiply raw score 0.823 by a multiplication factor 10 (i.e., 0.823*10=8.23), and then round the result to the nearest whole number, resulting in a relevancy score of 8. In this representative embodiment, the system would then apply the relevancy score to the single constituent component, resulting in the following calculated relevancy score: Alexander Graham Bell=8. A person of ordinary skill in the art will appreciate that the system may user any number of different mathematical formulas, including different multiplication factors or rounding techniques, to calculate the relevancy score disclosed herein.

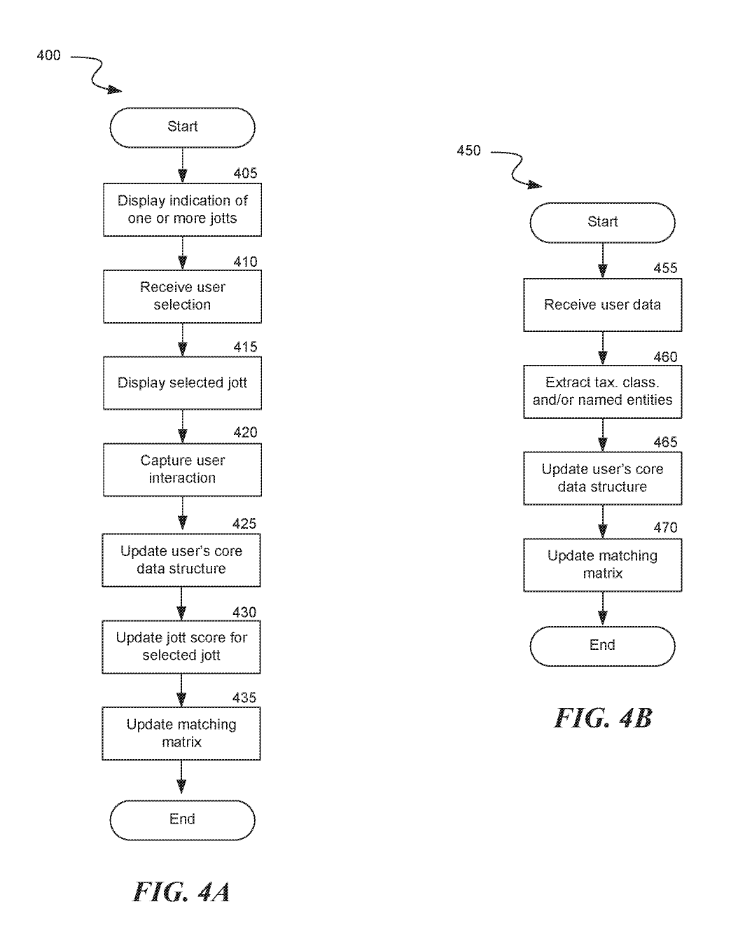

At step 360, the system determines whether any additional taxonomical classifications or named entities are present in the received jott. For each additional taxonomical classification or named entity that remains, the system repeats steps 340 and 350 to extract each respective taxonomical classification or named entity and compute the corresponding relevancy score. After the system processes all taxonomical classifications and named entities in the received jott, the system proceeds to step 370 to initialize the jott score for the new jott. The jott score is a numerical representation of the jott's popularity among users of the system or third-party platforms that are connected to the system (such as third-party apps or platforms that are connected to ecosystems provided by OpenDNA), and the system may initially assign a jott score that equals an average score corresponding to the entity that published the jott (e.g., a publisher, third party, advertiser, or another user). The initial jott score may be based on the average score of the publisher of the jott, such as an advertiser, user, or provider of a Rich Site Summary (RSS) feed that supplies the jott to the system. As described in more detail below, the system may subsequently update the jott score, for example as additional users of the system interact with the jott. The system repeats the steps of flowchart 300 each time a new jott is received and added to the system. As a result of adding new jotts to the system, the system builds a database containing multiple jotts, an example of which is illustrated in FIG. 4.

FIG. 4A is a flowchart 400 showing a method implemented by the customized internet searching and advertising system for processing a user interaction with a jott. At step 405, the system displays one or more jotts to a user. The system may display the jott as part of the user's personalized stream, which consists of one or more jotts in which the user may be interested. The one or more jotts in the user's personalized stream may be sorted according to an offset score that is indicative of an expected level of interest of the user with respect to the jott. In one embodiment, the system updates a user's personalized content stream by first obtaining a list of every taxonomical classification and named entity in the jott's profile. Then, for every taxonomical classification or named entity, the system obtains a list of users who have the context in his or her profile. For each user, the system then checks to ensure that the system has not made any changes to the jott for a fixed or variable period of time (e.g., 5 minutes). If the jott has been changed or altered within the period of time, then the system makes no changes to the jott.

However, if the jott has not been changed or altered within the period of time, then the system builds a list of taxonomical classification and named entities that the user and the jott have in common. For each taxonomical classification or named entity, the system multiplies the user's weight by the jott's weight to calculate the relevance of the taxonomical classification or named entity to the user. The system then adds the result to the jott's score to create an offset score that is unique to the user and the jott. Next, the system checks the user's content time limits for one or more types of content, for example news content or non-news content. If the jott falls outside of the user's content time limits, the system does not attempt to either add or remove the jott. By contrast, if the jott falls within the user's content time limits, then the system inserts the jott into the user's personalized content stream using the offset score to determine the jott's position within the user's personalized content stream. In this fashion, the jott's position in the user's personalized content stream is relative to all other jotts.

At step 410, the system receives a user selection of a jott, such as when a user clicks on a displayed jott or otherwise indicates an intention to view a displayed jott (e.g., hovering over the jott for a period of time or issuing a voice command to display a selected jott). At step 415, the system displays the selected jott to the user. When displaying a jott to a user, the system displays the actual content of the jott (e.g., the text of a newspaper article and related photographs, product placements, a video clip, or an audio clip). In addition, the system may display options that allow the user to dismiss the jott (i.e., remove the jott from the user's display), rate the content of the jott (e.g., a numerical rating, a star rating, or a positive/neutral/negative rating), share the jott with a contact, or link the jott to a social media account of the user. For example, a positive action may mean that the user saved the jott or selected it as a favorite, a neutral action may mean that the user simply read the jott, and a negative action may mean that the user affirmatively indicated a dislike for the jott. The way in which positive/neutral/negative indication is made available to the user largely depends on the type of application being used and how the application chooses to represent the types of engagement. Generally speaking, positive and negative actions are deliberately indicated by a user (e.g., by tapping a trash icon), while a neutral action is the default action type and may be indicative of neither a positive nor a negative interaction. For example, swiping or paginating through a series of jotts and pausing for a period of time (e.g., more than 2 seconds) on each would be interpreted as a series of neutral actions against those jotts.

At step 420, the system captures details related to the user's interaction with the displayed jott. When a user engages with the system content, for example via an authorized client, the system records multiple pieces of information regarding the user and the interaction. For example, the system may capture an indication of whether (and to whom) the user shared or linked the jott; an amount of time that the user spent engaging with the jott; an indication of whether the engagement was positive or negative (or the degree to which the engagement was positive or negative); the date and time of the engagement, including an indication of when data was consumed; a geographic location of the user; a profile location of the user; or a biometric reading of the user. By aggregating this data (and other data that the system has gathered, including taxonomical classifications and named entities featured in the jotts displayed by a user) over time, the system can understand with increasing accuracy and detail the taxonomical classifications and named entities in which the user has interest.

At step 425, the system updates the core data structure for the user. The core data structure allows the system to define a psychographic profile of each user, and it represents a continually evolving graph of the interests associated with the user. In its simplest form, the core data structure comprises one or more taxonomical classifications and/or named entities (e.g., cities, people, organizations, countries), each with a corresponding weight that is indicative of a degree of a user's interest in the respective taxonomical classification or named entity. The core data structure comprises one or more objects (and may in fact contain a virtually unlimited number of objects) such as {‘tech-news’: 5} or {‘Isaac Newton’: 8}, where ‘tech-news’ represents a taxonomical classification and ‘5’ represents the corresponding weight, and where ‘Isaac Newton’ represents a named entity and ‘8’ represents the corresponding weight. The weights calculated by the system may be relative weights. In other words, by adjusting the weight of each taxonomical classification or named entity in the same way, but independently of each other, the relative position of each weight with respect all of the user's weights has particular importance. The core data structure builds soft links between each jott and all taxonomical categories and named entities that are applied to the jott. Rather than applying fixed categories to content, the system uses the soft links to cross-reference relevant content in real time or near real time. The combination of the core data structure and its soft links allows the system to judge a relevance between a jot and a user, and one or more initial categories applied to a jott allows the system to efficiently filter large datasets while providing a useful reference when profiling.

Over time, the system therefore builds a unique core data structure for the user, which results in a leaderboard-type list of taxonomical classifications and/or named entities with which the user has engaged with the most. Because, in some embodiments, the system uses relative rather than absolute values to build a user's core data structure, the system is able to readily provide insight as to the degree of interest that a user has in a particular taxonomical category or named entity. For example, a user may have a core data structure that includes the following: [tech-news′: 200, ‘business-news’: 400, ‘Apple’: 120, ‘Microsoft’: 40, Windows′: 5]. In response to a third-party query for insight into a user's interest in technology, and in the Microsoft Windows operating system in particular, the system may return the following: “tech-news”: 50 “Windows”: 100. In this representative example, the returned value would indicate that the user's interest in technology is in the 50th percentile of the user's interests, and that the user's interest in the Microsoft Windows operating system is in the 100th percentile of the user's interests. A person of ordinary skill will appreciate that the system is capable of processing different types of queries from third parties and may return additional and/or alternative information in response to a query. For example, in one possible embodiment, the system may receive a query that includes a list of options provided by a third party, and may return an indication of the option that has the most importance to the user (or may return a listing of the options ranked in order of importance to the user).

In one embodiment, the system performs the actual update to a user's core data structure by recording the date, time, location, weather conditions and biometric readings of the user (such as heart rate, blood pressure, temperature) of the user's interaction with a jott that the user views, removing the viewed jott from the user's personal content stream, aggregating actions up to a variable count (e.g., accumulating 20 actions from the same user over a period of time determined by the age of the user in the system), and determining whether the user's core data structure should be updated. To determine whether an update is appropriate, the system builds a list of all taxonomical classifications and named entities related to the jotts with which the user interacted, calculates for each taxonomical classification and named entity a total relevance weight across all the jots (e.g., by summing the weights), calculates on a per-classification basis a weight across all jotts, comparing the group-wide classification weight against the weight of the classification against the user, and adjusting (if necessary) the weight of the classification against the user.

In another embodiment, the system determines whether each of the jott's taxonomical classifications or named entities is new to the user. If the taxonomical classification or named entity is new to the user, the system stores the new taxonomical classification or named entity for later processing, aggregates a variable number of new contexts for the user on a periodic basis, and adds the most common contexts to the user's core data structure. For existing users of the system, an increasing time period (typically a sliding window ranging from one or more hours to seven-to-ten days) related to the age of the user in the system is applied during which the user's actions are aggregated. If the taxonomical classification or named entity is not new to the user, then the system takes an average of the user's weight against the context and the context's weight against the jott. Then, using either the time spend viewing or a save/read more action, the system multiplies the above-referenced average by the time or an action-type factor, and then divides by a user-age factor which is defined by the total time for which the user has been known to the system. The system then takes this result and adds the result to the user's weight against the context.

At step 430, the system updates the jott score for the jott that was selected by the user. The system employs a scoring mechanism that monitors every user interaction with a jott and adds one or more values (fixed, pre-defined, variable, or otherwise) to a jott's score after each user interaction. The system therefore is able to present a jott to users based solely or primarily on the popularity of the jott (or the popularity of content contained in the jott). In addition, the system is able to apply a base score when deciding whether or not to include a particular jott in a user's personalized content stream. In some embodiments, the system does not perform negative scoring on a jott so that any user interaction can only result in a positive increase to the jott's score. In other embodiments, the system may employ negative scoring. In still other embodiments, a time-decay can be applied to a jott's score, such that the jott's score may be reduced over time. The system may increment a jott's score incrementally based on the user's interaction with the jott. For example, in one embodiment, the system may increment the jott score based on the time a user spends viewing the jott (e.g., increment the jott score by 1 point per second, for up to 21 seconds), based on whether a user saves the jott for later reading (e.g., increment the jott score by 21 points), or based on whether a user selects an option to visit a source webpage (e.g., increment the jott score by 21 points), or based on any external reading detected by third-party systems connected to the system that are directly associated with that user (e.g. the user's heart rate increasing when the user is viewing a jott). A person of ordinary skill in the art will appreciate that the monitoring and scoring mechanisms described herein enable the system to update jott scores in real time or near real time, thereby providing users of the system with content that takes into account recent interests that are indicated by users.

At step 435, the system updates the matching matrix, which is used to map each jott to all users for whom the jott is relevant. The system achieves this mapping by matching a jott's profile to the core data structure for each user of the system. The matching results in a sorted set of jotts that is unique to every user. During the matching process, each jott is given an offset score for each individual user to whom the jott is relevant based on the strength of the match between the user's interests (as indicated in the user's core data structure) and the taxonomical classifications and/or named entities present in the jott's profile. The sorted set of jotts allows the system to determine which jotts to present on each user's home screen or personalized content stream, as well as the order in which the jotts are presented to each user. As explained in more detail herein, when a user interacts with a displayed jott, the system records details of the interaction and initiates an update of the displayed jott's score and an update to the core data structure of the user who requested display of the jott.

FIG. 4B is a flowchart 450 showing a method implemented by the customized internet searching and advertising system for updating a matching matrix in response to receiving information about a user. At step 455, the system receives information about a user, such as the user's unique identifier (UUID), the user's unique UUID in the system's database, an amount of time spent engaging with content, whether the engagement was positive or negative, the date and time of the engagement, the geographic location of the interaction, weather data at the location of the user, a profile location of the user, and/or a biometric reading of the user.

At step 460, the system extracts one or more taxonomical concepts and/or named entities from the received data (as previously described with respect to step 340 of FIG. 3), updates the user's core data structure (as previously described with respect to step 425 of FIG. 4A), and updates the system's matching matrix (as previously described with respect to step 435 of FIG. 4A). As a practical example, the method of FIG. 4B would allow the system to receive a user's blood pressure reading or number of steps taken in a day, and then extract from this information taxonomical classifications related to health and fitness. If the system determines that the received blood pressure reading is above a healthy range or determines that the number of steps taken is indicative of a sedentary lifestyle, the system may extract taxonomical classifications related specifically to high blood pressure and exercise motivation. As a result, the system may assign a greater weight to jotts containing information on low sodium diets and exercise tips for beginners.

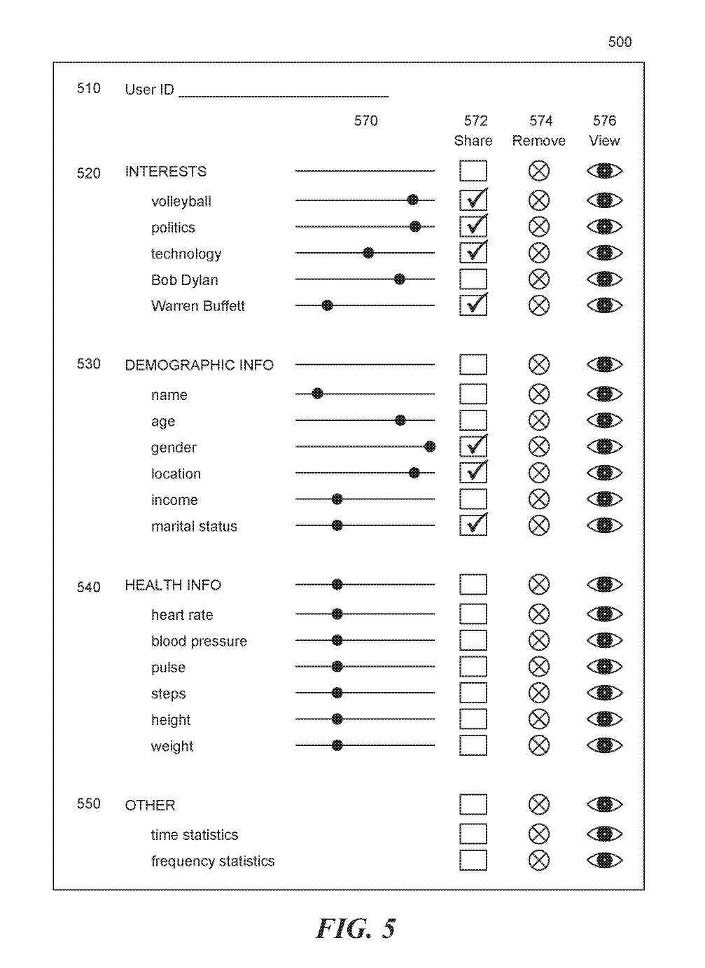

FIG. 5 is a sample privacy user interface 500 for allowing a user to control the user's personalized information that is maintained by the customized searching and advertising system. In particular, the system is adapted to provide an interface for a user to view the personalized information that the system stores for the user, remove personalized information that the user does not want the system to maintain, and choose which personalized information that the system may share with advertisers, third parties, publishers, other users, or any other entities. The provided interface (and/or its underlying functions) may be accessed via a publicly accessible app, website, or other software. Privacy user interface 500 includes a user identification 510, which may comprise the user's UUID or any other identifier that may used to uniquely identify the user. Interface 500 includes categories of the user's personalized information, including the user's interests 520 (e.g., volleyball, politics, technology, Bob Dylan, Warren Buffett), demographic information 530 (e.g., name, age, gender, location, income, martial status), health information 540 (e.g., heart rate, blood pressure, pulse, steps, height, weight), and other information 550 (e.g., time statistics such as an average amount of time per day reading jotts or an average time of day that the user typically reads jotts, or frequency statistics such as the number of jotts that the user reads daily).

Each type of personalized information contains an interest level slider bar 570, a share checkbox 572, a remove icon 574, and a view icon 576. Interest level slider bar 570 represents the user's relative interest level for each respective interest with respect to each other interest depicted in the interface 500. For example, the slider bar indicates a position for volleyball that is farther to the right than the position for Warren Buffett, thereby indicating that the user is more interested in volleyball than Warren Buffett. The values indicated in the interest level slider bar for each interest may be calculated in accordance with the determined weight for each taxonomical classification or named entity as described in more detail above. The user may adjust the slider bar for one or more interests to override (on either a permanent or temporary basis) the interest level computed by the system. In addition, the interest level slider bar next to the main categories (e.g., interests, demographic information, health info, other) may be used to simultaneously adjust all interests falling within the respective category. For example, the user may set the interest level slider bar next to the health information category 540 in order to set all of the interests in that category (i.e., heart rate, blood pressure, pulse, steps, height, weight) to the same value. Moreover, one or more interests may omit the interest level slider bar in instances where the system maintains user information that is not used to identify jotts in which the user may have interest (e.g., time statistics or frequency statistics).

Share checkbox 572 enables the user to specify which pieces of the user's personalized information may be shared. The user may select or deselect individual pieces of personalized information to enable or disable information sharing on a granular level. Remove column 574 enables the user to remove pieces of the user's personalized information such that the system no longer stores the information. In some embodiments, a user's removal of certain information has a permanent effect. That is, by removing certain personal information the system affirmatively prohibits storage of the same type of personal information that may be obtained by the system in the future. In other embodiments, the system may store similar data if the system receives such data in the future. View column 576 enables a user to view specific information that is stored by the system on a granular level. For example, the user may click the view icon next to the technology interest and receive a listing of jotts that the user has viewed that relate to technology. As another example, the user may click the view icon next to the blood pressure category and receive a listing of all blood pressure readings that the system has received for the user.

API Clients connect to the system API in order to create, read, update and delete (CRUD) data held by the system. They must be authorized to perform any action and may take the form of an iOS app, a web app or any other internet-connected software. The system-supplied content consumed by a user in an application includes text, audio and video content consumed by a user inside an application with a for-purpose graphical user interface (GUI), for example Jottr iOS or for example Jottr Web. When a user engages with content supplied by the system, inside an application which is connected to the system, the application will send some or all of the following data to the system API: (1) the content's unique identifier (UUID); (2) the time spent engaging with the content (e.g., in seconds); (3) an indication of whether the engagement was positive, negative, or neutral (defined via user input); (4) the date and time of the engagement and/or when data was consumed; (5) geographic location information associated with the interaction; (6) profile location of the user; (7) a biometric reading of the user; (8) weather data at location and time of user interaction and (9) additional data points that will further enhance the system's understanding of the user (such as additional data points that are used by systems offered by OpenDNA). Notification is received by the system API, is recorded in the system's data structure, and triggers a variety of asynchronous tasks which interpret, analyze and aggregate the user's engagement. This process can result in changes being made to the user's core data structure.

Online content consumed by a user outside an application includes text, audio, and video content consumed by a user outside an application with a for-purpose graphical user interface (GUI). When a user is engaging with online content which is not supplied by the system, there are various ways in which this engagement can be sent to the system API, including via a user-installed browser plugin or a website-installed plug-in (e.g., a JavaScript plugin).

A user installed browser plug-in will send some or all of the following data to the system API: (1) the URL of the webpage visited by the user; (2) the user's UUID in the system's database; (3) the time spent viewing that webpage; (4) the depth to which the user scrolled down the webpage's content; (4) an indication of whether the user engaged with any audio or video content on the webpage; (5) the date and time of the engagement; (6) an optional user-defined input indicating a positive or negative engagement with the webpage; and (7) geographic location information of the browsing data to ascertain browsing behavior at different locations.

This data will be received by the system API and will be recorded in the system's data structure. A series of asynchronous tasks will be triggered which will cause the webpage viewed by the user to be analyzed using Natural Language Processing (NLP) to extract taxonomical information, named entities (personalities, companies, countries etc.) and any other relevant information which the system can use to understand the context and content of the webpage. The data derived from the NLP process is used by the system to interpret, analyze and aggregate the user's engagement. The process can result in changes being made to the user's core data structure.

A website or app plugin will be installed by the owner of a third-party website. The plugin will rely on cookies in the user's browser to find or set a UUID to uniquely identify the user in the system database. When browsing a website or using an app which has installed an authorized plugin, the plugin will send some or all of the following data to the system API: (1) the URL of the webpage visited by the user; (2) the user's UUID in the system's database; (3) the time spent viewing that webpage; (4) the depth to which the user scrolled down the webpage's content; (5) an indication of whether the user engaged with any audio or video content on the webpage; (6) the date and time of the engagement; and (7) an optional user-defined input indicating a positive or negative engagement with the webpage.

Notification will be received by the system API and will be recorded in the system's data structure. A series of asynchronous tasks will be triggered which will cause the webpage viewed by the user to be analyzed using Natural Language Processing (NLP) to extract taxonomical information, named entities (personalities, companies, countries etc.) and any other relevant information which the system can use to understand the context and content of the webpage. The data derived from the NLP process is used by the system to interpret, analyze and aggregate the user's engagement. The process can result in changes being made to the user's core data structure. Website information once analyzed will be cached within the system.

API Clients connect to the system API in order to create, read, update and delete (CRUD) data held by the system. They must be authorized to perform any action and may take the form of an iOS app, a web app or any other internet-connected software. Any authorized API client may connect to the system on behalf of a user and retrieve the content to display to that user. This is achieved by sending the user's unique id (UUID) as recorded in the database to the API. The API will then return curated content in the form of jotts to the client, which may then be displayed to the user.

An authorized API client may also connect to the system in order to allow a user to search the system's content. This is achieved by sending the user's UUID to the system API, along with the user-submitted search query. The system's search engine can return search results tailored to the user's core data structure. The search results will be made up of curated content in the form of jotts which the API Client can display to the user. An authorized API client may connect to the system on behalf of a user and retrieve that user's core data structure in order that the API client may infer the user's interests with the goal of personalizing the user's experience. This is achieved by sending the user's unique id (UUID) as recorded in the system's database to the system API.

In one embodiment, the process of creating an advertisement in the system disclosed in the application follows four main steps. First, the advertiser creates their own content, for example a piece of text, or an image, video, or piece of audio content (each of which may contain supplemental text). Second, the advertiser submits the advertisement to the system for analysis and simulation. The second step further comprises (a) using NLP to analyze the advertiser's content to extract the advert's taxonomical contexts and named entities, giving the system a clear picture of the content's context, (b) running a simulation to establish how many users are likely to engage with the advertisement, (c) making available to advertisers the results of the simulation in a browser-based interactive graphical interface, thereby allowing the advertiser to effectively visualize the psychographic profiles and demographic information related to the users who will see the advertisement, and (d) adjusting, by the advertiser and using the same graphical interface, both the advertiser's content and the contexts of the advertisement in order to reach a different subset of users. Third, releasing (after confirmation) the advertisement to users and inserting the advertisement into the streams of users who have an established interest in the contexts of the jott. Fourth, subjecting the advertisement to the same scoring mechanisms as every other jott such that advertisements must be positively engaged with by the users who view them in order for the advertisement to remain in a high position in the user's stream.

FIG. 2, is a block diagram representation of a machine in the example form of a customized searching and advertising system 115 within which a set of instructions, for causing the machine to perform any one or more of the methodologies or modules discussed herein, may be executed. The customized searching and advertising system 115 includes a processor, memory, non-volatile memory, and an interface device. Various common components (e.g., cache memory) are omitted for illustrative simplicity. The customized searching and advertising system 115 is intended to illustrate a hardware device on which any of the components described in this specification can be implemented. The customized searching and advertising system 115 can be of any applicable known or convenient type. The components of the customized searching and advertising system 115 can be coupled together via a bus or through some other known or convenient device.

This disclosure contemplates the customized searching and advertising system 115 taking any suitable physical form. As example and not by way of limitation, customized searching and advertising system 115 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, customized searching and advertising system 115 may include one or more customized searching and advertising system 115; be unitary or distributed; span multiple locations; span multiple machines; or reside in a cloud, which may include one or more cloud components in one or more networks. Where appropriate, one or more customized searching and advertising systems 115 may perform without substantial spatial or temporal limitation one or more steps of one or more methods described or illustrated herein. As an example and not by way of limitation, one or more customized searching and advertising systems 115 may perform in real time or in batch mode one or more steps of one or more methods described or illustrated herein. One or more customized searching and advertising systems 115 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the customized searching and advertising system 115. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing and entire large program in memory may not even be possible.

Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the customized searching and advertising system 115. The interface can include an analog modem, ISDN modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted reside in the interface.

In operation, the customized searching and advertising system 115 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all exam page on pies in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While processes or blocks are presented in a given order, alternative embodiments may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, certain aspects of the disclosure may be embodied as a means-plus-function claim under 35 U.S.C. §112(f), or in other forms, such as being embodied in a computer-readable medium. (Any claims intended to be treated under 35 U.S.C. §112(f) will begin with the words “means for”.) Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description may describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

I/We claim:

1. A method for generating one or more jotts and matching the generated jotts to a user, comprising:
receiving one or more content pieces, wherein each of the received content pieces comprises text, audio, or video;
generating a jott for each received content piece, wherein the generated jott includes a taxonomical classification or a named entity, and a corresponding relevancy score;
generating a core data structure for a user,
wherein the generated core data structure includes one or more taxonomical classifications or named entities in which the user has expressed an interest, and
wherein the generated core data structure includes a corresponding weight for each of the one or more taxonomical classifications or named entities;
determining one or more matching jotts, wherein the matching is based on a comparison of the one or more generated jotts to the generated core data structure for the user; and
displaying an indication of the one or more matching jotts.

2. The method of claim 1, wherein the relevancy score is indicative of an accuracy of the taxonomical classification or named entity to the received content that corresponds to the generated jott.

3. The method of claim 1, wherein the weight for each of the one or more taxonomical classifications or named entities indicates a relative interest of the user with respect to one or more different taxonomical classifications or named entities.

4. The method of claim 1, further comprising receiving a user selection of a displayed jott and displaying the jott in response to the received user selection or in response to information derived from a third-party biometric reading created by a platform connected to the system via an Application Program Interface (API).

5. The method of claim 4, further comprising updating a score for the displayed jott in response to receiving the user selection.

6. The method of claim 1, wherein the one or more matching jotts are displayed in an order determined by a strength of the determined match.

7. The method of claim 4, further comprising updating the core data structure for the user in response to receiving the user selection, wherein the update to the core data structure includes altering the weight of a taxonomical classification or a named entity in the core data structure.

8. The method of claim 4, wherein displaying the jott includes displaying an option for the user to provide a rating for the jott.

9. The method of claim 1, wherein generating a jott for each received content piece includes assigning one or more initial, high-level category to the generated jott.

10. The method of claim 1, wherein the generated jott further includes a sample that is extracted from the received content.

11. A computer-readable storage medium with instructions stored thereon that, when executed by a computing system, cause the computing system to perform a method to generate one or more jotts and match the generated jotts to a user, the method comprising:
receiving one or more content pieces, wherein each of the received content pieces comprises text, audio, or video;
generating a jott for each received content piece, wherein the generated jott includes a taxonomical classification or a named entity, and a corresponding relevancy score;
generating a core data structure for a user,
wherein the generated core data structure includes one or more taxonomical classifications or named entities in which the user has expressed an interest, and
wherein the generated core data structure includes a corresponding weight for each of the one or more taxonomical classifications or named entities;
determining one or more matching jotts, wherein the matching is based on a comparison of the one or more generated jotts to the generated core data structure for the user; and
displaying an indication of the one or more matching jotts.

12. The computer-readable storage medium of claim 11, wherein the relevancy score is indicative of an accuracy of the taxonomical classification or named entity to the received content that corresponds to the generated jott.

13. The computer-readable storage medium of claim 11, wherein the weight for each of the one or more taxonomical classifications or named entities indicates a relative interest of the user with respect to one or more different taxonomical classifications or named entities.

14. The computer-readable storage medium of claim 11, further comprising receiving a user selection of a displayed jott and displaying the jott in response to the received user selection or in response to information derived from a third-party biometric reading created by a platform connected to the system via an Application Program Interface (API).

15. The computer-readable storage medium of claim 14, further comprising updating a score for the displayed jott in response to receiving the user selection.

16. The computer-readable storage medium of claim 11, wherein the one or more matching jotts are displayed in an order determined by a strength of the determined match.

17. The computer-readable storage medium of claim 14, further comprising updating the core data structure for the user in response to receiving the user selection, wherein the update to the core data structure includes altering the weight of a taxonomical classification or a named entity in the core data structure.

18. The computer-readable storage medium of claim 14, wherein displaying the jott includes displaying an option for the user to provide a rating for the jott.

19. The computer-readable storage medium of claim 11, wherein generating a jott for each received content piece includes assigning one or more initial, high-level category to the generated jott.

20. The computer-readable storage medium of claim 11, wherein the generated jott further includes a sample that is extracted from the received content.

21. A method for generating one or more jotts and matching the generated jotts to a user, comprising:
determining a plurality of interests for a user, wherein each interest is determined based on one or more taxonomical classifications or named entities in which the user has expressed an interest;
displaying, for each determined interest, a visual indication of the determined interest and a visual indication of one or more actions that the user may take with respect to the determined interest,
wherein each of the one or more actions is selected from a group consisting of (a) modifying a degree to which the user is interested in the determined interest, (b) allowing or prohibiting the system to share the determined interest, (c) removing the determined interest for the user, or (d) viewing details related to the determined interest;
receiving a selection corresponding to one of the displayed actions; and
executing an action that corresponds to the received selection.

22. The method of claim 21, wherein the received selection corresponds to (a) modifying a degree to which the user is interested in the determined interest.

23. The method of claim 22, wherein the modification is made on a permanent basis.

24. The method of claim 22, wherein the modification is made on a temporary basis.

25. The method of claim 21, wherein the received selection corresponds to (b) allowing or prohibiting the system to share the determined interest.

26. The method of claim 21, wherein the received selection corresponds to (c) removing the determined interest for the user.

27. The method of claim 26, wherein the removal is on a permanent basis.

28. The method of claim 21, wherein the received selection corresponds to (d) viewing details related to the determined interest.

29. The method of claim 21, wherein the details related to the determined interest include an indication of one or more jotts that the user has previous selected, the one or more jotts being related to the determined interest.

30. The method of claim 21, further comprising updating a core data structure of the user in response to receiving the selection corresponding to one of the displayed actions.
